(19) United States
(12) Patent Application Publication
(10) Pub. No.: US 2015/0196153 A1
(43) Pub. Date: Jul. 16, 2015

(54) PASTA POT AND STRAINER COMBINATION

(71) Applicants: BRIAN J. SYKES, MISSION VIEJO, CA (US); LEONARD R. STAMPER, ANAHEIM, CA (US)

(72) Inventors: BRIAN J. SYKES, MISSION VIEJO, CA (US); LEONARD R. STAMPER, ANAHEIM, CA (US)

(21) Appl. No.: 14/156,016

(22) Filed: Jan. 15, 2014

(51) Int. Cl. A47J 19/00

(52) U.S. Cl. CPC A47J 19/005

(57) ABSTRACT

To enable more efficient cooking, draining and straining of cooking ingredients that are boiled or steamed, the invention adds structural features enabling a cooking strainer to fit in a cooking pot, specifically, pivot members on the cooking strainer, which fit in and are supported rotatably by receivers on the inner sidewalls of the cooking pot.

### CROSS-REFERENCE TO RELATED APPLICATION

This application claims the benefit of U.S. Provisional Application No. 61/848,930, filed Jan. 15, 2013.

A need exists for a combination product that is structured so that a user can boil pasta then drain it without using a standard colander, that is structured so that a user can steam foods in a unit that also is useful for boiling pasta, and that has structural elements that enable the use to place the container in which the pasta or steamed foods are held in a safe and convenient receiver.

As depicted and disclosed in the Figures herewith, the combination of a cooking pot with a pair of receiver pivot points situated near the opening of the pot, a lid preferably with a glass top, and a basket dimensioned to fit within the cooking pot and having a plurality of openings to allow water or steam to pass through the basket and having pivot studs dimensioned to be received in the receiver pivot points on the cooking pot, will serve the need that exists.

### DESCRIPTION OF THE DRAWINGS

FIG. 1 depicts an embodiment of the cooking pot, a lid, and an embodiment of the strainer or basket secured rotatably in receivers, and suspended within the pot.

FIG. 2 depicts the FIG. 1 elements of a pot, and an embodiment of the strainer raised from the receivers.

FIGS. 3 and 4 depict embodiments of the guide, securement, rotation and support elements of the FIG. 2 pot and strainer.

FIG. 5 depicts an embodiment of surface mounting of an embodiment of a receiver of the type shown in FIG. 4.

FIG. 6 depicts the basket in cutaway view, showing an embodiment of the stud on the basket being received in the receiver on the pot.

FIG. 7 shows the FIG. 6 elements, with the stud set in the receiver.

### DETAILED DESCRIPTION

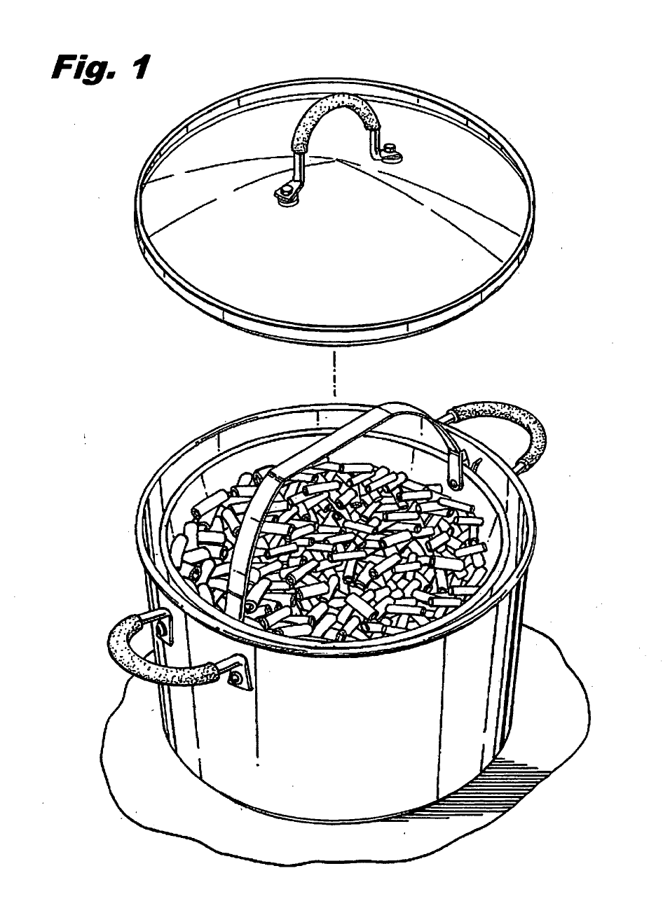

The pasta pot and strainer combination of the present invention are made more functional when structural elements are added that enable straining and draining of the pasta or vegetables. The pot 10 typically has a circumferential rim 19 and sidewall 20 joined to a bottom or base, which form an open top vessel capable of holding water, liquid and cooking ingredients. The strainer or basket 11 typically has a circumferential rim 21, somewhat smaller in diameter than the sidewall of the pot, and has a hemispherical strainer wall joined to the rim. The strainer wall is formed with a plurality of drain holes, particularly in the lower portion of the wall. FIG. 1 depicts an embodiment of the pot with its rim and bottom, and of a hemispherical basket with its rim and drain holes. In other embodiments, a portion of hemispherical strainer opposite the rim may be flat.

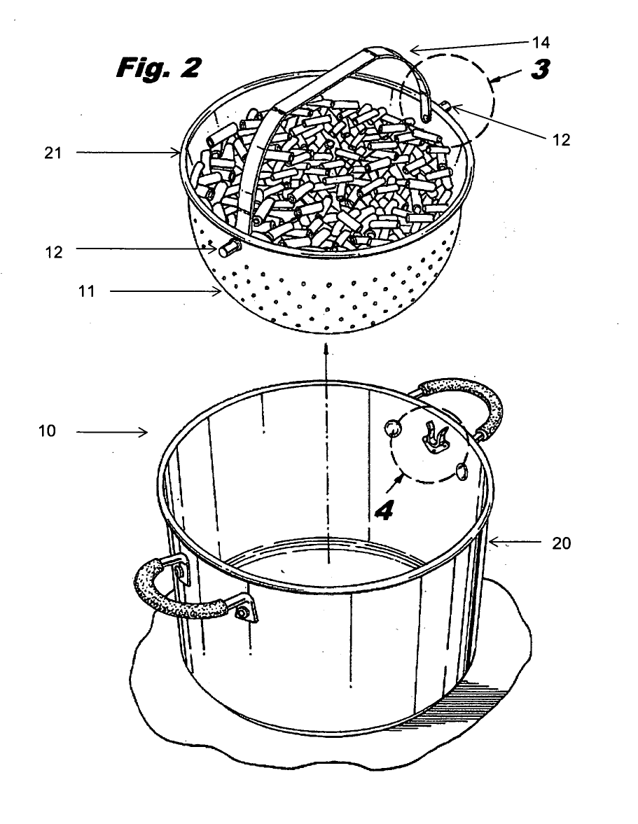

The structural elements added to the strainer 11, to enable cooking and draining of the contents, include a pair of studs or pivot members 12 mounted on opposite sides of the strainer wall adjacent to the rim 13, and dimensioned according to the space between the outer circumference of the rim 21 and the inner circumference of the pot sidewall 20. The pair of pivot members preferably are rigid, solid except for a mount, and cylindrical, and when the strainer is in the pot, the pivot members 12 are generally parallel with the bottom of the pot. In one preferred embodiment of the strainer, a handle 14 is added that extends from one of the pair of studs 12 across the rim of the strainer 11, to the stud 12 on the opposite side of the strainer basket. A utilitarian version of the handle is depicted in FIG. 2, and one mode for the handle 14 to be joined to the stud 12 is depicted in FIG. 3. The handle enables downward force against the studs to position the basket in the pot, and upward force to remove it from the pot. In an alternative embodiment, not depicted, the handle is formed of a pair of handholds, one of each on the portion of the rim of the basket near the pivot members.

The structural features added to the pot 10 and its sidewall 20, which enable cooking and draining of the contents of the strainer, include a pair of receivers 15 mounted on opposite sides of the pot sidewall, as depicted in the FIG. 5 embodiment, and adjacent to the rim atop the pot sidewall. The receivers have an internal dimension that is set to be mateable with the studs 12, and have one exterior dimension to permit the receiver to fit in the space between the outer circumference of the rim 21 and the inner circumference of the pot sidewall 20 to which the receiver is mounted. In the preferred embodiment, the pair of studs on the strainer can rest on the upper elements of the pair of receivers, or can be supported on the lower elements of the receivers, as depicted in the FIG. 7 embodiment.

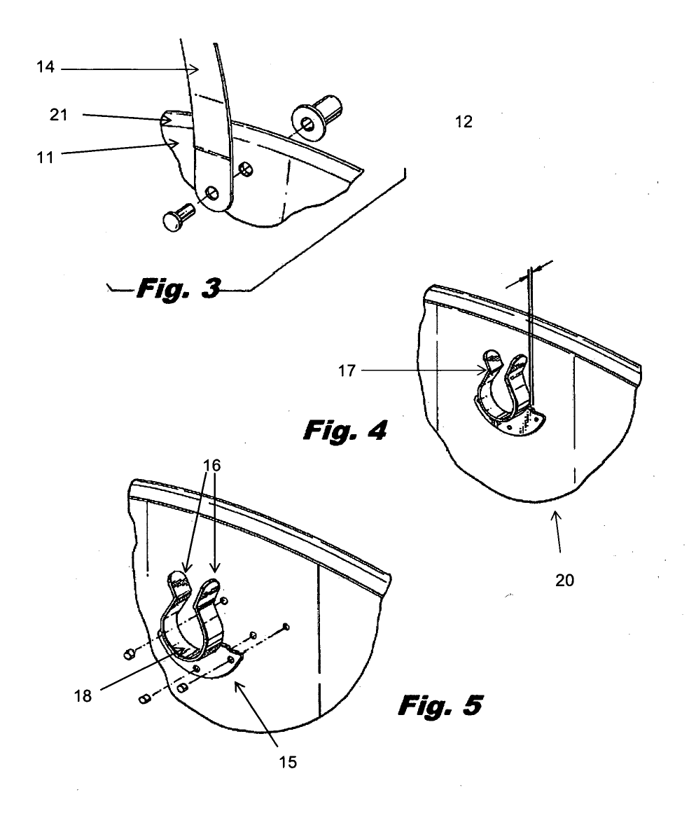

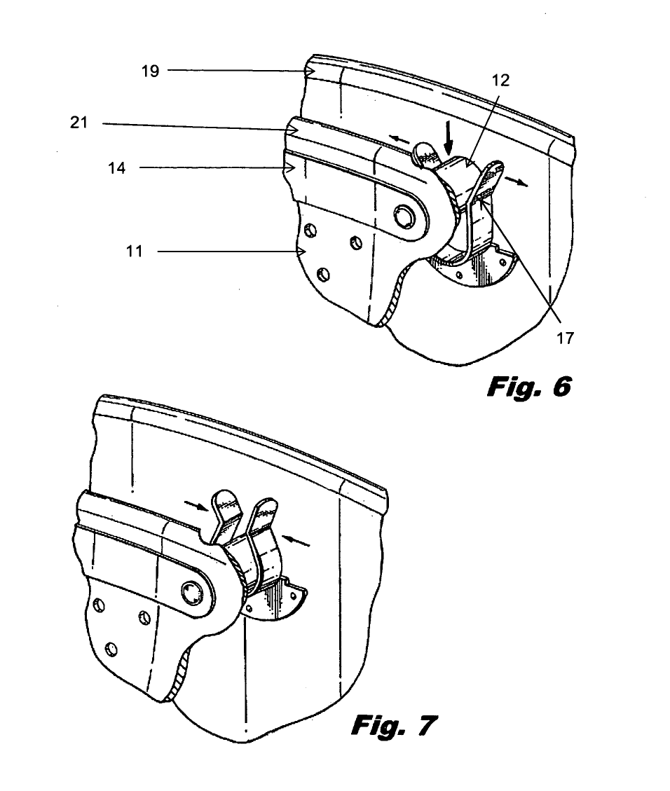

The mateable arrangement of the studs on the strainer and the receivers on the pot are depicted in FIGS. 6 and 7. One preferred embodiment of the receivers 15, by reference to the depiction FIG. 4 starting at the portion nearest the rim of the pot, has upper, acceptors 16 that branch out from the central area defined by the entire structure of the receiver. The acceptor portions serve as guides to receive the studs, as well as guiding the basket to resting points on the receivers. Below the pair of acceptor portions 16, and integrally formed therewith, are clasp or jaw portions 17. The space between the pair of clasps is predetermined by the size of the pivot members 12 mounted on the basket, which members will be measurably larger in diameter than the distance between the pair of clasps. The best mode of making the receivers is to use flexible or spring material, which enables the clasp portions to be pushed apart when downward or upward force is placed on the studs, thereby enabling the studs to pass through the clasps, as depicted in FIG. 6, and then, for each clasp to flex or spring back to the normal positions as in FIG. 7. Below the clasp or jaw portions 17 of each receiver 15 is the pivot and support portion 18. The pivot and support portion is preferably semi-circular or arcuate, which enables the stud to be supported rotatably within that semi-circle or arc. In all embodiments, the two branches of each receiver are not in parallel relation, and the lowest portion is curved and so not linear or in parallel relation. In the preferred embodiment, the receiver is mounted alongside the sidewall of the pot, leaving some space therebetween, as depicted in FIG. 4.

In the preferred embodiment, the position of the studs on the basket and the receivers on the pot are mounted at positions predetermined by the difference in distance from the rim of the basket to the bottom, and from the rim of the pot to the bottom. Preferably, the basket when supported by the studs in the receivers will not be in contact with the bottom of the pot, and preferably, the distance between the supported basket and the pot will predetermined so that when the pot is tipped to pour out liquid that the strainer will rotate freely within the receivers such that the contents of the strainer will not pour out.

With the inventive structure, the typical use would be for water to be added to the pot, and ingredients such as pasta to be boiled or vegetables to be steamed would be added to the strainer. The strainer would be lifted by the handle, and placed with the studs on the basket in contact with the acceptor portions of the receivers on the pot, then a downward force on the handle would push open clasps, and the studs would come to be supported and rotatable within the pivot and support portion of the receivers. The lid would be placed on the pot, and the contents cooked. When the food is ready to serve, and the lid removed, the pot would be tipped to pour out some or all of the liquid, and the rotatable support of the basket would keep the contents from pouring out. With an upward force on the handle of the basket, the studs would move through the jaw portions. Then, the basket can be removed for the contents to be served, or the basket can rest on the acceptors until service of the contents is desired.

We claim:

1. Apparatus to enable draining and straining liquids from a pot with sidewalls and a bottom forming a vessel for liquids, comprising:
A cooking strainer formed with a rim joined to a hemisphere portion perforated with a plurality of drain holes; a pair of studs mounted on opposite sides of said hemisphere portion adjacent to said rim; said rim and said hemisphere portion with said studs dimensioned to fit within said pot; said studs having a first predetermined circumferential dimension, and
A pair of receivers mounted on the inside of said sidewall of said pot and on opposite sides thereof, and adjacent to the top of said sidewall; each said receiver comprising a pair of acceptor portions branching away from the other, a pair of clasp portions each of said pair adjacent the other at a distance larger than the diameter of each of said pair of studs, and an arcuate support portion integrally formed with said pair of clasp portions and said pair of acceptor portions of said pair of receivers; and said arcuate support portion having a second predetermined circumferential dimension larger than said first predetermined circumferential dimension and dimensioned to enable said studs to be rotatably supported in said arcuate support portions of said pair of receivers.

2. The apparatus of claim 1, wherein on each of said pair of receivers, each of said acceptor portions are in a non-parallel relation.

3. The apparatus of claim 1, wherein said hemisphere portion has a substantially flat bottom portion.

4. The apparatus of claim 1, wherein said pair of receivers are mounted at a distance from the top of said sidewall of said pot predetermined by the difference in length between the distance from said top and bottom of said sidewall, and the distance from said rim of said cooking strainer and the bottom of said hemispheric portion, and predetermined to enable said bottom of said hemispheric portion to be located above said bottom of said sidewall when said cooking strainer is supported by said pair of receivers.
